(19) United States
(12) Patent Application Publication
(10) Pub. No.: US 2020/0393832 A1
(43) Pub. Date: Dec. 17, 2020

(54) MOBILE BODY CONTROL DEVICE, MOBILE BODY CONTROL METHOD, AND RECORDING MEDIUM

(71) Applicant: NEC Corporation, Minato-Ku, Tokyo (JP)

(72) Inventors: Masumi ICHIEN, Tokyo (JP); Masatsugu OGAWA, Tokyo (JP)

(73) Assignee: NEC Corporation, Minato-ku, Tokyo (JP)

(21) Appl. No.: 16/975,211

(22) PCT Filed: Mar. 7, 2018
(86) PCT No.: PCT/JP2018/008762

§ 371 Date: Aug. 24, 2020

(51) Int. Cl. G05D 1/00; G05D 1/02

(52) U.S. Cl. CPC G05D 1/0088; G05D 1/0219; G05D 2201/0207; G05D 1/028; G05D 1/0094

(57) ABSTRACT

Provided is a mobile body control device for controlling a mobile body and reliably and quickly performing sensing in all of a target area, even if the sensing of the moving object is inadequate in the target area. The device includes: a disposition control unit that controls the disposition of the mobile body in the target area; a completed range calculation unit that, when the target area comprises small areas, performs sensing of small areas in high-priority order, and calculates a sensing-completed range comprising small areas; an uncompleted range calculation unit that calculates a sensing-uncompleted range, the range comprising small areas within the target area, based on the sensing-completed range and a reference range; and an update unit that updates so that the priority of the small areas corresponding to the sensing-incomplete range is greater than the priority of the sensing-completed range.

### TECHNICAL FIELD

The present invention relates to a sensing action performed autonomously by a mobile body, and particularly relates to a mobile body control device and the like that are capable of controlling a mobile body to perform sensing quickly and reliably even when there is a location with insufficient sensing.

### BACKGROUND ART

There is a trend that a sensing operation in a specific area is to be performed efficiently and safely by autonomously controlling a mobile body (such as an unmanned vehicle) to which a sensing device such as a sensor or a camera is mounted. For example, a flyable mobile body to which a camera is mounted is caused to perform searching and monitoring in an area such as a disaster area or a vast area where investigation by a human hand is difficult. One of requirements in a case where a mobile body is used is to perform sensing for an entire target area without an omission and to acquire information on the target area reliably and quickly. For example, this requirement is essential when an autonomously-operated mobile body is caused to search a disaster area for a missing person or the like reliably and quickly.

PTL 1 discloses a technique of reliably performing sensing and controlling in a target area. With this technique, a mobile operation robot moves while detecting a distance from a wall during moving near the wall, and thus generation of an unworked area such as a corner is prevented. PTL 2 discloses a similar technique. With this technique, when a plurality of sensing robots detect a target object, an omission in detecting the target object is prevented by changing a processing method in such a way as to improve sensing resolution according to a detection event. PTL 3 discloses a similar technique. With this technique, in order to cover a surface of an unknown area, moving within a map is performed according to information on an unsearched/searched state, while detecting an edge and expanding a target area. In addition to these, PTL 4 and NPL 1 are known as literatures relating to the present invention.

### CITATION LIST

### Patent Literature

[PTL 1] Japanese Unexamined Patent Application Publication No. 2003-131737
[PTL 2] Japanese Patent No. 4087104
[PTL 3] Japanese Patent No. 6162955
[PTL 4] Japanese Unexamined Patent Application Publication No. 2016-048474

### Non Patent Literature

[NPL 1] Atsuyuki Okabe, Atsuo Suzuki (Apr. 1, 1992) “Saiteki Haichi no Suri” [Mathematics for Optimal Arrangement]. Asakura Shoten

### SUMMARY OF INVENTION

### Technical Problem

However, the techniques disclosed in PTLs 1 to 3 attempt to prevent an omission of a sensing cover area, based on an object (a target object, a wall, or the like) that is present in a fixed manner, and cannot quickly deal with a sudden and unpredictable omission of a sensing cover area. For example, in a case where an obstacle suddenly appears, when sensing is performed by a camera, an area behind the obstacle cannot be subjected to sensing. Further, when sensing is performed by a radar and a sonar, performance varies depending on an environment and a time, and sensing data may vary.

In view of the above-mentioned problem, an object of the present invention is to provide a mobile body control device and the like that are capable of controlling a mobile body and performing sensing reliably and quickly for the entire target area even when there is a location with insufficient sensing in the target area during sensing performed by the mobile body that is autonomously operated.

### Solution to Problem

In view of the above-mentioned problem, a mobile body control device according to a first aspect of the present invention includes:

an arrangement control unit that controls arrangement of a mobile body for sensing in a target area being subjected to the sensing by the mobile body;

a completed-range calculation unit that, when the target area is constituted of a plurality of small areas and sensing is performed subsequently from the small area with a high priority level, calculates a sensing-completed range being constituted of one or more of the small areas in which the sensing is completed;

an uncompleted-range calculation unit that calculates a sensing-uncompleted range, on the basis of the calculated sensing-completed range and a reference range being subjected to the sensing, the sensing-uncompleted range being constituted of one or more of the small areas with the sensing being uncompleted in the target area; and

an update unit that performs update in such a way that the priority level of one or more of the small areas associated with the calculated sensing-uncompleted range is higher than that of the sensing-completed range.

A mobile body control system according to a second aspect of the present invention includes:

a plurality of mobile bodies each including the above-mentioned mobile body control device, wherein

a plurality of the mobile body control devices are communicable with each other via a wireless communication network.

A mobile body according to a third aspect of the present invention includes:

the above-mentioned mobile body control device;

a drive unit that causes the mobile body to move in a target area according to control from the mobile body control device; and

a sensor unit that performs sensing and transmits a performance result to the mobile body control device.

A mobile body control method according to a fourth aspect of the present invention includes:

controlling arrangement of a mobile body for performing sensing in a target area being subjected to the sensing by the mobile body, performing sensing subsequently from the small area with a high priority level, and calculating a sensing-completed range being constituted of one or more of the small areas in which the sensing is completed;

calculating a sensing-uncompleted range, on the basis of the calculated sensing-completed range and a reference range being subjected to the sensing, the sensing-uncompleted range being constituted of one or more of the small areas with the sensing being uncompleted in the target area; and

performing update in such a way that the priority level of one or more of the small areas associated with the calculated sensing-uncompleted range is higher than that of the sensing-completed range.

A mobile body control program according to a fifth aspect of the present invention causes a computer to perform:

controlling arrangement of a mobile body for performing sensing in a target area being subjected to the sensing by the mobile body, performing sensing subsequently from the small area with a high priority level, and calculating a sensing-completed range being constituted of one or more of the small areas in which the sensing is completed;

calculating a sensing-uncompleted range, on the basis of the calculated sensing-completed range and a reference range being subjected to the sensing, the sensing-uncompleted range being constituted of one or more of the small areas with the sensing being uncompleted in the target area; and

performing update in such a way that the priority level of one or more of the small areas associated with the calculated sensing-uncompleted range is higher than that of the sensing-completed range.

The mobile body control program may be stored in a non-temporal computer-readable storage medium.

### Advantageous Effects of Invention

According to the present invention, there can be provided a mobile body control device that are capable of controlling a mobile body and performing sensing reliably and quickly for the entire target area even when there is a location with insufficient sensing in the target area during sensing performed by the mobile body that is autonomously operated.

### BRIEF DESCRIPTION OF DRAWINGS

FIG. 1 is a diagram illustrating a configuration example of a mobile body control device according to a first example embodiment of the present invention.

FIG. 2 is a diagram illustrating one example of a relationship between an actual sensing area and a sensing reference shape (a fan-like shape).

FIG. 3 is a diagram illustrating one example of a relationship between an actual sensing area and a sensing reference shape (a circular shape).

FIG. 4 is a diagram illustrating one example of a sensing reference shape that is set from a past moving trace.

FIG. 5 is a flowchart illustrating one example of processing by the mobile body control device according to the first example embodiment of the present invention.

FIG. 6 is a diagram illustrating one example of a locational relationship of an actual sensing range and a location with insufficient sensing.

FIG. 7 is a diagram illustrating a configuration example of a mobile body control device and a configuration example of a mobile body control system according to a second example embodiment of the present invention.

FIG. 8 is a flowchart illustrating one example of sensing processing for the mobile body by the mobile body control device according to the second example embodiment of the present invention.

FIG. 9 is a diagram illustrating one example of information that is transmitted from a mobile body to another mobile body.

FIG. 10 is a diagram illustrating one example of information that is transmitted from a mobile body to another mobile body.

FIG. 11 is a flowchart illustrating one example of sensing processing for another mobile body according to the second example embodiment of the present invention.

FIG. 12 is a diagram illustrating a configuration example of a mobile body control device according to a third example embodiment of the present invention.

FIG. 13 is a diagram illustrating a configuration example of an information processing device applicable to each of the example embodiments.

### EXAMPLE EMBODIMENT

Now, with reference to the drawings, example embodiments of the present invention are described. In the following description of the drawings, identical or similar parts are denoted with identical or similar reference symbols. However, the drawings schematically illustrate the configurations of the example embodiments of the present invention. Further, the example embodiments of the present invention described below are merely examples, and can be changed as appropriate without departing from the essence.

### First Example Embodiment

### (Mobile Body)

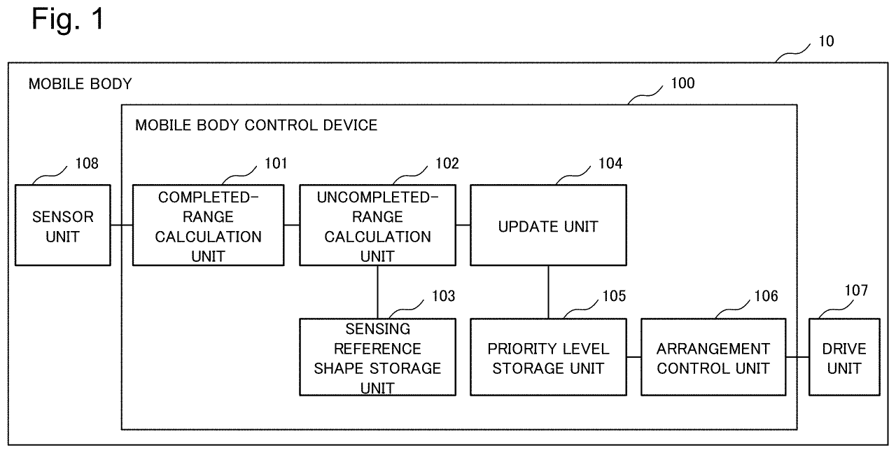

As illustrated in FIG. 1, a mobile body 10 according to a first example embodiment of the present invention includes a mobile body control unit (mobile body control device) 100, a drive unit 107, and a sensor unit 108.

The mobile body 10 autonomously controls arrangement of the mobile body while following an operation, which is set in advance or is received via wireless communication, and acquiring information from the sensor unit 108. In each of the example embodiments of the present invention, a target area in which the mobile body 10 performs an operation is constituted of a plurality of small areas, and a priority level is associated with each of pieces of information that can specify the small areas. The mobile body 10 controls arrangement of the mobile body according to priority level values associated with the small areas. For example, the mobile body 10 moves its own location in such a way as to perform sensing first in a small area with a high priority level. For example, an arrangement method for a plurality of resources described in NPL 1 is applicable to this control. NPL 1 uses a case where a plurality of installations (for example, mail boxes and the like) are arranged optimally according to a population density of a city, and is applied to arrangement control of the mobile body 10 by replacing, for example, the population density with a priority level of a target area and the installations with the mobile body 10. The mobile body 10 performs sensing in the target area, but may be unable to perform sensing for the entire target area when a defect is caused in the sensor unit 108 or arrangement of the mobile body is changed due to an external factor such as a gust of wind.

The drive unit 107 is a drive device for changing arrangement of the mobile body 10, and is as an engine for rotating a propeller in a case of a flying device or a power mechanism and an engine for rotating a wheel in a case of a land-traveling device, for example.

The sensor unit 108 is a sensor for acquiring information on a peripheral condition of the mobile body 10, and is a sensing device such as a camera, a radar, and a sonar, for example.

As illustrated in FIG. 1, the mobile body control unit 100 includes a completed-range calculation unit 101, an uncompleted-range calculation unit 102, a sensing reference shape storage unit 103, an update unit 104, a priority level storage unit 105, and an arrangement control unit 106.

The completed-range calculation unit 101 is connected with the sensor unit 108 in a communicable manner, and causes the sensor unit 108 to perform sensing subsequently from a small area with a high priority level within the target area. Initial values of the priority level of the small areas are preferably set to the same value (for example, one) in such a way as to perform sensing all over the entire target area. After performing sensing, the completed-range calculation unit 101 calculates a sensing-completed range constituted of one or more small areas in which the sensing is completed.

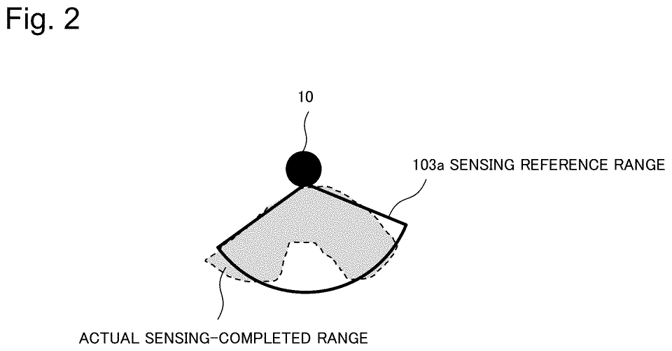

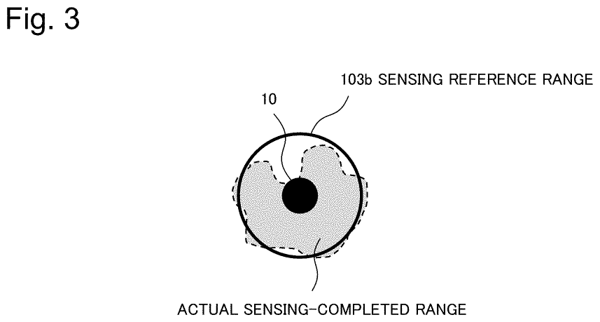

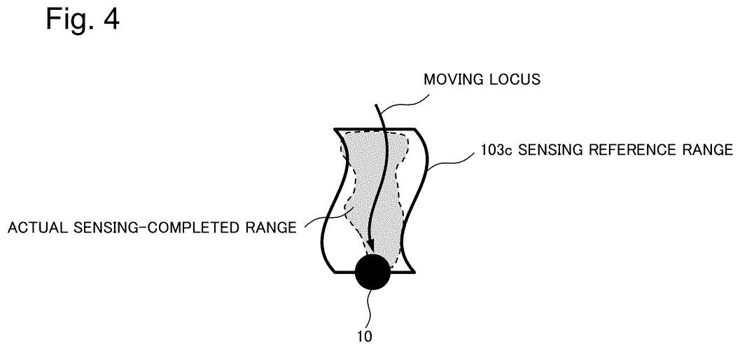

The sensing reference shape storage unit 103 stores information relating to a reference range (sensing reference range) for determining whether sensing is performed effectively. Various shapes are exemplified as the sensing reference range. For example, as illustrated in FIG. 2, the sensing reference range is an area 103a in a fan-like shape having a location of the mobile body 10 as a center. Alternatively, as illustrated in FIG. 3, the sensing reference range is an area 103b in a circular shape having a location of the mobile body 10 as a center. Further, as illustrated in FIG. 4, the sensing reference range may be an area 103c including a moving trace with the mobile body 10 as a starting point.

On the basis of the sensing reference range, which is stored in the sensing reference shape storage unit 103 and is subjected to sensing, and the sensing-completed range calculated by the completed-range calculation unit 101, the uncompleted-range calculation unit 102 calculates a range (sensing-uncompleted range) in which sensing is uncompleted, which is constituted of one or more small areas. Specifically, the uncompleted-range calculation unit 102 extracts a location (sensing-uncompleted range) where sensing is insufficient within the target area after completion of sensing.

The priority level storage unit 105 stores priority levels that are associated with each of the plurality of small areas in the target area. Note that the initial values of the priority level may be all the same (for example, one).

The update unit 104 updates the priority levels of the small areas according to a location with insufficient sensing. For example, the update unit 104 performs update in such a way that a priority level of one or more small areas associated with the sensing-uncompleted range is higher than that of the sensing-completed range (for example, when the initial value is one, the updated priority level is two).

The arrangement control unit 106 controls arrangement (movement) of the mobile body 10 in the target area being subjected to sensing by the mobile body 10. The arrangement control unit 106 is connected with the drive unit 107 in a communicable manner, and the drive unit 107 moves a location of the mobile body according to a control signal transmitted from the arrangement control unit 106. The above-mentioned method disclosed in NPL 1 may be used for the arrangement control. Note that the method for the arrangement control is not limited to this.

### (Operation of Mobile Body)

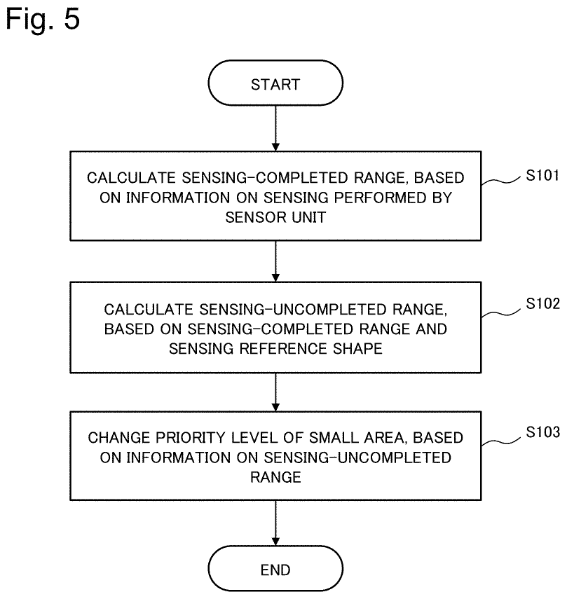

Next, processing for priority level update that is performed by the mobile body control device 100 mounted to the mobile body 10 is described with reference to a flowchart illustrated in FIG. 5.

On the assumption, the sensor unit 108 of the mobile body control device 100 follows an instruction from the completed-range calculation unit 101, and performs sensing in the target area.

In Step S101, the completed-range calculation unit 101 calculates a sensing-completed range, on the basis of a result of performing the sensing that is received from the sensor unit 108. As a method for calculating the sensing-completed range, for example, when the sensor unit 108 is a camera, a method for obstacle detection is used, and it is determined that sensing is completed in a range captured by the camera. For example, when the sensor unit 108 is a radar or a sonar, it is determined that, among observation data acquired from the radar or the sonar, an area with a accuracy level (a threshold value for an error) lower than a predetermined value is a sensing-completed range. Note that the determination method is not limited to these.

In Step S102, on the basis of the sensing-completed range calculated in Step S101 and the reference range, which is stored in the sensing reference shape storage unit 103 and is subjected to sensing, the uncompleted-range calculation unit 102 calculates a location with insufficient sensing (uncompleted range). A shape being the sensing reference range is selected in advance and set, according to a property of the sensor unit 108 and characteristics of an operation performed by the mobile body 10. FIGS. 2 to 4 illustrate examples of the sensing-completed range and the sensing reference range (sensing reference shape). When a sensor such as a camera with directivity is used, the sensing reference shape is preferably a fan-like shape with the mobile body 10 as a center (starting point) (see FIG. 2). When a sensor such as a radar without directivity is used, the sensing reference shape is preferably a circular shape with the mobile body 10 as a center (see FIG. 3). Further, as illustrated in FIG. 4, the sensing reference shape may be set from a past moving trace of the mobile body.

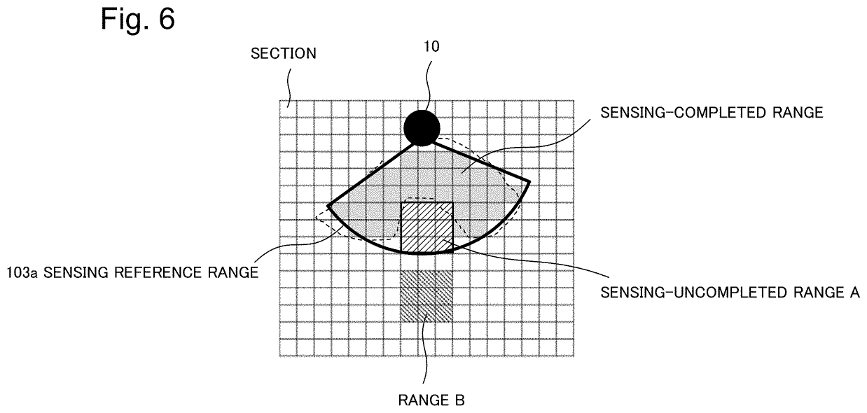

As one example of the calculation method for an uncompleted range, there is known a method in which a target area is divided in a grid-like manner to form a plurality of sections (small areas) as a plurality of small areas and whether sensing is uncompleted is calculated for each of the small sections. For example, when the sensing reference shape is a fan-like shape (see FIG. 2), a target area is divided in a grid-like manner to form a plurality of sections, and a sensing-uncompleted range A is extracted by comparing the sections with the sensing-completed range and the sensing reference range, as illustrated in FIG. 6.

In Step S103, the update unit 104 changes a priority level of the sensing-uncompleted range A. As one specific example of changing a priority level, a method of changing a priority level of a section associated with the sensing-uncompleted range A is considered. Further, when a sensor with directivity is used, change may be made to a priority level of an area B at a location away from the mobile body 10 with respect to the sensing-uncompleted range A in a vector direction extending from the mobile body 10 to the sensing-uncompleted range A. This is because, when the mobile body 10 performs sensing in the area B as a target, the sensing-uncompleted range A is also subjected to sensing. As a method of changing a priority level of a small area (for example, a section), there are known a method of making change in all the small areas in a fixed manner (a priority level value is multiplied by a fixed ratio value and is increased), a method of making change gradually along elapse of time, and the like. When change is made along elapse of time, design may be made in such a way that a priority level of a location with insufficient sensing is gradually higher and a priority level of a location other than that is gradually lower.

Note that, when the small areas are associated with the sections, the uncompleted-range calculation unit 102 calculates a sensing-uncompleted range by allocating the sections to the sensing-completed range and the sensing reference range and extracting a section, the section being within the sensing reference range but not being included in the sensing-completed range.

With this, the processing for priority level update that is performed by the mobile body 10 is completed.

After the processing for priority level update that is performed by the mobile body 10 is completed, the sensor unit 108 of the mobile body 10 performs sensing in the sensing-uncompleted range according to the updated priority level. After performing the sensing, the mobile body control unit 100 repeats the processing again from Step S101. The series of processing is performed until a sensing-uncompleted range is absent.

### (Effects of First Example Embodiment)

According to the first example embodiment of the present invention, the mobile body control device 100 is capable of controlling the mobile body 10 and performing sensing reliably and quickly for the entire target area even when a location with insufficient sensing is generated at the time of sensing by the mobile body 10 that is autonomously operated in the target area. The reason for this is that the update unit 104 updates a priority level of one or more small areas associated with the sensing-uncompleted range in such a way that the priority level of the sensing-uncompleted range is higher than that of the sensing-completed range, that the completed-range calculation unit 101 performs sensing subsequently from a small area with a high priority level, and that the sensing-completed range constituted of the small areas where sensing is completed is calculated. With this, the mobile body control device 100 is capable of controlling the mobile body 10 to perform sensing again in the sensing-uncompleted range.

### Second Example Embodiment

In the first example embodiment of the present invention, one mobile body performs sensing quickly and reliably for the entire target area by performing sensing again in an area with insufficient sensing. However, other mobile bodies present in the vicinity of the mobile body may perform sensing in the area with insufficient sensing. In a second example embodiment of the present invention, a method of performing sensing quickly and reliably for the entire target area with a plurality of mobile bodies is described.

### (Mobile Body)

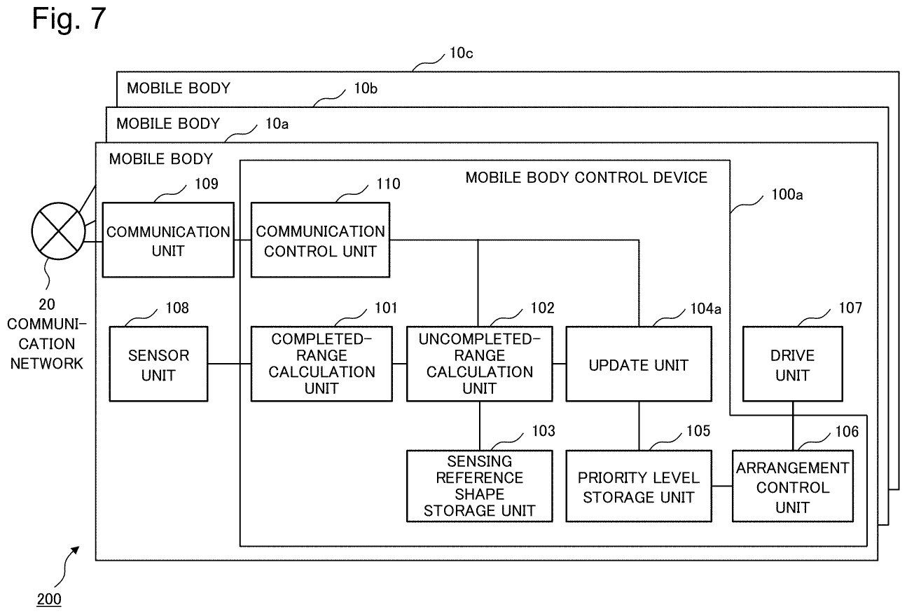

As illustrated in FIG. 7, a mobile body control system 200 according to the second example embodiment of the present invention includes a plurality of mobile bodies 10a, 10b, and 10c (hereinafter, also described as mobile bodies 10a to 10c). The mobile bodies 10a to 10c are connected to one another in a communicable manner via a communication network 20. The communication network 20 is a route (network) that is used for exchanging information among the mobile bodies 10a to 10c, and is a wireless local area network (LAN) or near field communication, for example. The communication network 20 may include the Internet, an intranet, and the like.

The mobile body 10a includes a mobile body control unit (mobile body control device) 100a, a drive unit 107, a sensor unit 108, and a communication unit 109. The mobile body control device 100a includes a completed-range calculation unit 101, an uncompleted-range calculation unit 102, a sensing reference shape storage unit 103, an update unit 104a, a priority level storage unit 105, an arrangement control unit 106, and a communication control unit 110.

The communication unit 109 is an antenna or the like that transmits and receives a radio wave for communicating with the other mobile bodies 10b and 10c via the communication network 20.

The communication control unit 110 controls the communication unit 109, and controls communication with the other mobile bodies 10b and 10c. The communication control unit 110 transmits information relating to a location of the sensing-uncompleted range and location information on the mobile body 10a to the other mobile bodies 10b and 10c (external devices). The communication control unit 110 receives location information on the sensing-uncompleted range and location information on the other mobile bodies 10b and 10c from the other mobile bodies 10b and 10c. The communication control unit 110 is connected with the uncompleted-range calculation unit 102 and the update unit 104a, and follows an instruction from the uncompleted-range calculation unit 102 or the update unit 104a and controls communication.

On the basis of the location information of the sensing-uncompleted range and the location information of the mobile body 10a, the update unit 104a determines a location of one or more small areas being subjected to priority level update. Further, on the basis of the location information of the sensing-uncompleted range and the location information of the external devices that are received from the external devices (other mobile bodies), the update unit 104a updates priority levels of the plurality of small areas for the mobile body 10a.

The other devices are similar to those described in the first example embodiment. Further, the other mobile bodies 10b and 10c have configurations similar to that of the mobile body 10a. Note that, in FIG. 7, the three mobile bodies 10a to 10c are given, but the number of mobile bodies included in the mobile body control system 200 is not limited.

### (Operation of Mobile Body)

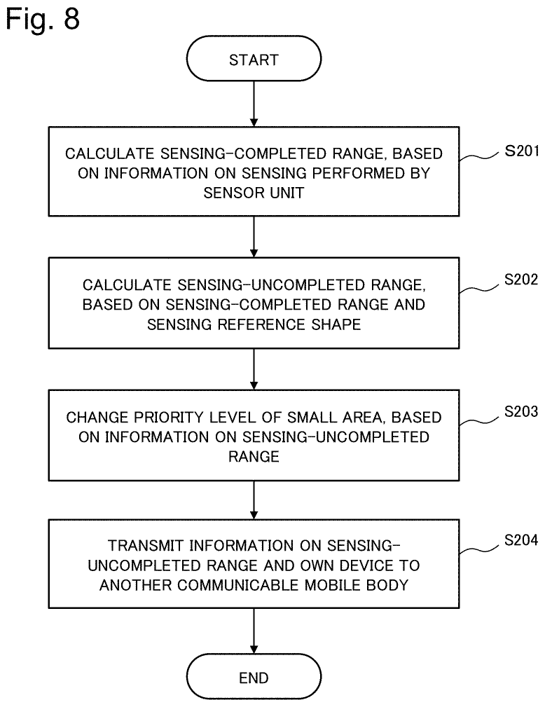

Next, processing for priority level update performed by the mobile bodies 10a to 10c in the mobile body control system 200 is described with reference to a flowchart illustrated in FIG. 8. On the assumption, the sensor unit 108 of the mobile body control device 100a follows an instruction from the completed-range calculation unit 101, and performs sensing in the target area.

First, Steps S201 to S203 are similar to Steps S101 to S103 being the operation in the flowchart of the first example embodiment.

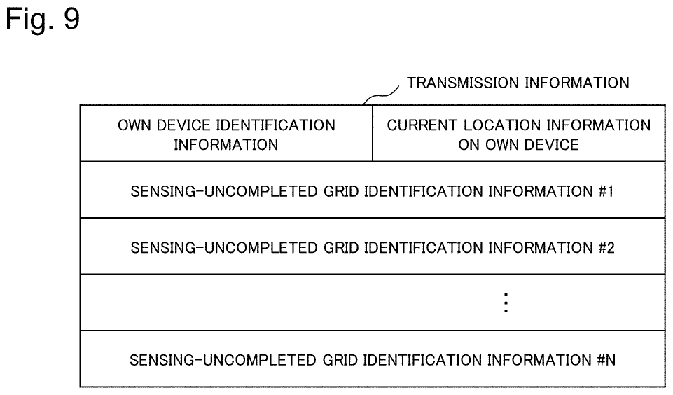

In Step S204, the update unit 104a issues a notification relating to completion of the priority level change to the communication control unit 110 and the uncompleted-range calculation unit 102. The uncompleted-range calculation unit 102 that receives the notification divides the information on the sensing-uncompleted range for each section, and generates sensing-uncompleted grid (section) identification information relevant to each section (see FIG. 9). The grid-identification information is information capable of identifying a certain section uniquely. For example, it is assumed that the target area is expressed with 100 sections constituted of 10 rows and 10 columns. In this case, a coordinate (long., lat.) expressing each section (1≤long.≤10, 1≤lat.≤10) is the grid-identification information. The 100 sections may be denoted with numbers from 1 to 100, and the numbers may be regarded as the grid-identification information.

The communication control unit 110 transmits transmission information (see FIG. 9), which is acquired by adding information capable of identifying the mobile body 10a uniquely (mobile body identification information) and information on a current location of the mobile body 10a to one or more pieces of the generated grid-identification information, to the other mobile bodies 10b and 10c via the communication unit 109 and the communication network 20.

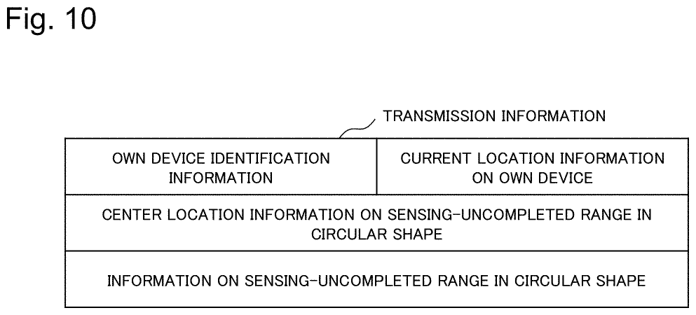

As one mode of reducing a size of the transmission information, in addition to the mobile body identification information and the information on a current location of the mobile body, the shape of the sensing-uncompleted range may be mapped in a simple figure, and information capable of identifying the figure may be transmitted. FIG. 10 is an example of the transmission information in a case where a sensing-uncompleted range is mapped in a perfect circle, and includes center location information on the sensing-uncompleted range in a circular shape and radius information on the sensing-uncompleted range in such circular shape. This is effective in a case where the sensing-uncompleted range is substantially circular.

The communication control unit 110 may perform transmission to all the other mobile bodies that are present in a communicable manner within the communication network 20, or may perform transmission to a specific mobile body. With this, the processing for priority level update that is performed by the mobile bodies 10a to 10c is completed.

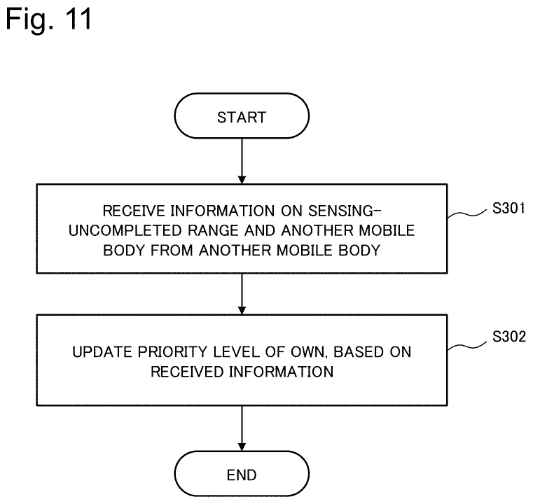

Next, an operation of priority level update performed by the other mobile body 10b (or the mobile body 10c) having received the transmission information is described with reference to a flowchart illustrated in FIG. 11.

In Step S301, the mobile body 10b receives the transmission information from the mobile body 10a via the communication unit 109. The communication control unit 110 of the mobile body 10b transmits the received transmission information to the update unit 104a.

In Step S302, the update unit 104a updates a priority level of the mobile body 10a according to the received transmission information. With this, the operation of priority level update performed by the mobile body 10b is completed.

After the processing for priority level update is completed, the sensor unit 108 of the mobile body 10b follows the updated priority level, and perform sensing in the sensing-uncompleted range.

### (Effects of Second Example Embodiment)

According to the second example embodiment of the present invention, the mobile body control device 100a is capable of controlling the other mobile bodies 10b and 10c and performing sensing reliably and quickly for the entire target area even when a location with insufficient sensing is generated at the time of sensing by the mobile body 10a that is autonomously operated in the target area. Specifically, the mobile body control device 100a is capable of performing control in such a way that an omission of a sensing cover area of a mobile body can be covered quickly by another mobile body. The reason for this is that the mobile body 10a transmits the transmission information in which a priority level of the sensing-uncompleted range of the mobile body is set to be higher than that of the sensing-completed range, to the other mobile bodies 10b and 10c, and that the other mobile bodies 10b and 10c updates, on the basis of the transmission information, a priority level of a small area (section) associated with the sensing-uncompleted range, and performs sensing subsequently from a small area with a high priority level. With this, the mobile body control device 100a is capable of controlling the other mobile bodies 10b and 10c to perform sensing again in the range where sensing by the mobile body 10a is uncompleted.

According to the second example embodiment of the present invention, reliability and quickness of autonomous sensing in the target area can be enhanced more as compared to the first example embodiment in which a single mobile body performs sensing. The reason for this is that the information on the sensing-uncompleted range is shared by the plurality of mobile bodies, the priority levels in the area information on the plurality of mobile bodies are changed on the basis of the information, and the plurality of mobile bodies can be controlled to perform sensing again in the sensing-uncompleted range.

### Modification Example of Second Example Embodiment

When the plurality of mobile bodies 10b and 10c are capable of performing sensing in the uncompleted range of the mobile body 10a, a mobile body arranged closer to the mobile body 10a may be first caused to perform sensing. In this case, the mobile body 10a also receives the transmission information from the plurality of mobile bodies 10b and 10c, compares the current location information on the mobile bodies 10b and 10c, which are contained in the transmission information, with the current location information on the mobile body 10a, and requests sensing to a mobile body arranged in a closer location. With this, the mobile bodies 10a to 10c cooperate with each other more easily, and idle motion of the mobile bodies 10a to 10c as a whole can be reduced.

### Third Example Embodiment

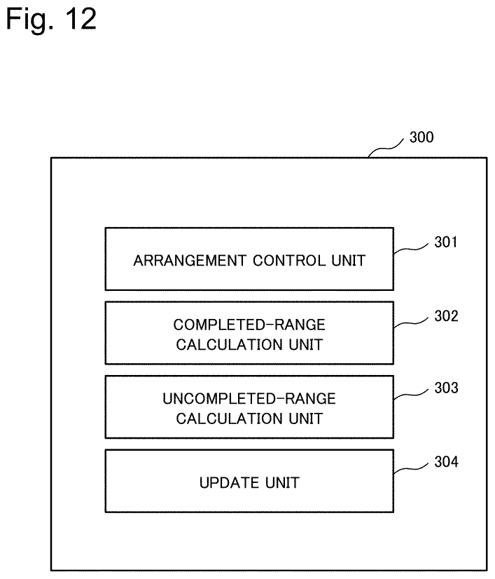

As illustrated in FIG. 12, a mobile body control device 300 according to a third example embodiment of the present invention includes an arrangement control unit 301, a completed-range calculation unit 302, an uncompleted-range calculation unit 303, and an update unit 304.

The arrangement control unit 301 controls arrangement of mobile bodies in a target area being subjected to sensing by the mobile bodies. The target area is constituted of a plurality of small areas.

The completed-range calculation unit 302 performs sensing subsequently from a small area with a high priority level, and calculates a sensing-completed range constituted of one or more small areas in which the sensing is completed.

On the basis of the calculated sensing-completed range and a reference range being subjected to sensing, the uncompleted-range calculation unit 303 calculates a sensing-uncompleted range in the target area, which is constituted of one or more small areas in which sensing is uncompleted.

The update unit 304 performs update in such a way that a priority level of one or more small areas associated with the calculated sensing-uncompleted range is higher than that of the sensing-completed range.

According to the third example embodiment of the present invention, the mobile body control device 300 is capable of controlling the mobile body and performing sensing reliably and quickly for the entire target area even when a location with insufficient sensing is generated at the time of sensing by the mobile body that is autonomously operated in the target area. The reason for this is that the update unit 304 updates a priority level of one or more small areas associated with the sensing-uncompleted range in such a way that the priority level of the sensing-uncompleted range is higher than that of the sensing-completed range, the completed-range calculation unit 302 performs sensing subsequently from a small area with a high priority level, and the sensing-completed range constituted of the small areas in which sensing is completed is calculated. With this, the mobile body control device 300 is capable of controlling the mobile body to perform sensing again in the sensing-uncompleted range.

### (Information Processing Device)

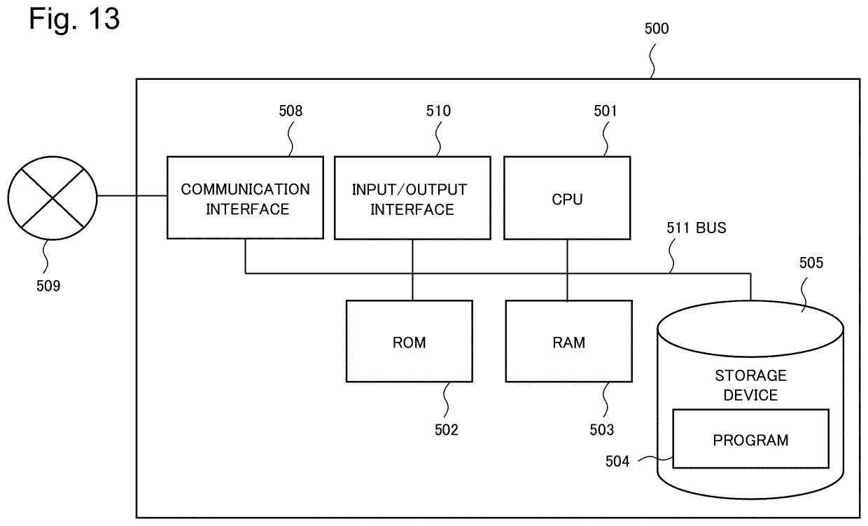

In each of the above-mentioned example embodiments of the present invention, a part or the entirety of each of the constituent elements of the mobile body control device illustrated in FIGS. 1, 7, and 12 and the like can be achieved through use of a freely-selected combination of an information processing device 500 and a program as illustrated in FIG. 13, for example. As one example, the information processing device 500 includes the following configuration.
A central processing unit (CPU) 501
A read only memory (ROM) 502
A random access memory (RAM) 503
A program 504 that achieves functions of the constituent elements
A storage device 505 that stores the program 504 and other data
A communication interface 508 that is connected with a communication network 509
An input/output interface 510 that performs input/output of data
A bus 511 that connects the constituent elements with one another

Each of the constituent elements of the mobile body control device according to each of the example embodiments of the present application is achieved when the CPU 501 acquires and executes the program 504 that achieves those functions. The program 504 for achieving the functions of the constituent elements of the mobile body control device is stored in the storage device 505 or the RAM 503 in advance, for example, and is read by the CPU 501 as needed. The program 504 may be supplied to the CPU 501 via the communication network 509.

Various modification examples are conceivable for a method of achieving each device. For example, the mobile body control device may be achieved by a freely-selected combination of an information processing device and a program, which is provided separately for each of the constituent elements. Further, the plurality of constituent elements included in the mobile body control device may be achieved by a freely-selected combination of one information processing device 500 and a program.

Further, a part or the entirety of each of the constituent elements of the mobile body control device is achieved by another all-purpose or dedicated circuit, a processor, or a combination of those. This may be constituted of a single chip or a plurality of chips connected via a bus.

A part or the entirety of each of the constituent elements of the mobile body control device may be achieved by a combination of the above-mentioned circuit or the like and a program.

When a part or the entirety of each of the constituent elements of the mobile body control device is achieved by a plurality of information processing devices, circuits, or the like, the plurality of information processing devices, circuits, or the like may be arranged in a centralized or decentralized manner.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

10, 10a, 10b, 10c Mobile body
20 Communication network
100, 100a Mobile body control device
101 Completed-range calculation unit
102 Uncompleted-range calculation unit
103 Sensing reference shape storage unit
104 Update unit
105 Priority level storage unit
106 Arrangement control unit
107 Drive unit
108 Sensor unit
109 Communication unit
110 Communication control unit
200 Mobile body control system
300 Mobile body control device
301 Arrangement control unit
302 Completed-range calculation unit
303 Uncompleted-range calculation unit
304 Update unit
500 Information processing device
501 CPU
503 RAM
504 Program
505 Storage device
508 Communication interface
509 Communication network
510 Input/output interface
511 Bus

What is claimed is:

1. A mobile body control device comprising
a processor;
a memory having stored therein computer instructions,
the instructions causing the processor acting as:
an arrangement control unit configured to control arrangement of a mobile body for sensing in a target area being subjected to the sensing by the mobile body;
a completed-range calculation unit configured to, when the target area is constituted of a plurality of small areas and sensing is performed subsequently from the small area with a high priority level, calculate a sensing-completed range being constituted of one or more of the small areas in which the sensing is completed;
an uncompleted-range calculation unit configured to calculate a sensing-uncompleted range, based on the calculated sensing-completed range and a reference range being subjected to the sensing, the sensing-uncompleted range being constituted of one or more of the small areas with the sensing being uncompleted in the target area; and
an update unit configured to perform update in such a way that the priority level of one or more of the small areas associated with the calculated sensing-uncompleted range is higher than that of the sensing-completed range.

2. The mobile body control device according to claim 1, wherein
the small areas are sections acquired by dividing the target area in a grid-like manner, and
the uncompleted-range calculation unit further configured to
calculate the sensing-uncompleted range by allocating associated sections to the sensing-completed range and the reference range and extracting a section being within the reference range but not being included in the sensing-completed range.

3. The mobile body control device according to claim 1, wherein
the update unit further configured to
determine a location of one or more of the small areas being subjected to update of the priority level, based on location information on the sensing-uncompleted range and location information of the mobile body.

4. The mobile body control device according to claim 1, the processor further comprising
a communication control unit configured to control transmission of information related to a location of the sensing-uncompleted range and location information on the mobile body to an external device.

5. The mobile body control device according to claim 4, wherein
the communication control unit further configured to receive location information on the sensing-uncompleted range and location information on the external device from the external device, and
the update unit further configured to update priority levels of a plurality of small areas of an mobile body, based on the received location information on the sensing-uncompleted range and the location information on the external device.

6.-7. (canceled)

8. A mobile body control method comprising:
controlling arrangement of a mobile body for performing sensing in a target area being subjected to the sensing by the mobile body, performing sensing subsequently from the small area with a high priority level, and calculating a sensing-completed range being constituted of one or more of the small areas in which the sensing is completed;
calculating a sensing-uncompleted range, based on the calculated sensing-completed range and a reference range being subjected to the sensing, the sensing-uncompleted range being constituted of one or more of the small areas in which sensing is uncompleted in the target area; and
performing update in such a way that the priority level of one or more of the small areas associated with the calculated sensing-uncompleted range is higher than that of the sensing-completed range.

9. A non-transitory computer readable recording medium that stores a mobile body control program for causing a computer to perform:
controlling arrangement of a mobile body for performing sensing in a target area being subjected to the sensing by the mobile body, performing sensing subsequently from the small area with a high priority level, and calculating a sensing-completed range being constituted of one or more of the small areas in which the sensing is completed;
calculating a sensing-uncompleted range, based on the calculated sensing-completed range and a reference range being subjected to the sensing, the sensing-uncompleted range being constituted of one or more of the small areas in which sensing is uncompleted in the target area; and
performing update in such a way that the priority level of one or more of the small areas associated with the calculated sensing-uncompleted range is higher than that of the sensing-completed range.

10. The mobile body control device according to claim 2, wherein
the update unit further configured to
determine a location of one or more of the small areas being subjected to update of the priority level, based on location information on the sensing-uncompleted range and location information of the mobile body.

11. The mobile body control device according to claim 2, the processor further comprising
a communication control unit configured to control transmission of information related to a location of the sensing-uncompleted range and location information on the mobile body to an external device.

12. The mobile body control device according to claim 3, the processor further comprising
a communication control unit configured to control transmission of information related to a location of the sensing-uncompleted range and location information on the mobile body to an external device.
